(19) United States
(12) Patent Application Publication
(10) Pub. No.: US 2013/0033373 A1
(43) Pub. Date: Feb. 7, 2013

(54) CHILD CAR SEAT SAFETY SYSTEM AND METHOD

(71) Applicant: Sherine Elizabeth Thomas, Austin, TX (US)

(72) Inventor: Sherine Elizabeth Thomas, Austin, TX (US)

(21) Appl. No.: 13/197,620

(22) Filed: Aug. 3, 2011

(51) Int. Cl. B60Q 1/00

(52) U.S. Cl. 340/457.1

(57) ABSTRACT

Method and system are disclosed for a car seat buckle with a transmitter to a portable alarm unit such as a key ring. In some embodiments, the alarm system may transmit information to a PDA or phone in the form of an e-mail, text, video, phone call or alarm. Alternatively (or in addition), car seat safety alarm may be activated by pressure sensors, temperature sensors or distance sensors in the car seat.

### FIELD OF THE INVENTION

The present invention relates generally to child safety systems and, more particularly, to a system and method for alarming a caretaker when a child is inadvertently left in a car seat.

### BACKGROUND OF THE INVENTION

Infant or child car seats are legally required in some form in every state in the United States and many other countries. Since 1998, it has been estimated that more than five hundred child deaths are attributed to heat exposure or hyperthermia because of a child being left unattended in a vehicle. Over half of these deaths have been estimated to have occurred because the caregiver forgot the child was in the vehicle. See, Catherine McLaren, Jan Null and James Quinn, Heat Stress from Enclosed Vehicles: Moderate Ambient Temperatures Cause Significant Temperature Rise in Enclosed Vehicles, Pediatrics (Official Journal of American Academy of Pediatrics; Vol. 116, No. 1 Jul. 2005 at pp.e109; see also Jan Null, Hypothermia Deaths of Children in Vehicles, http://ggweather.com/heat, Department of Geosciences at San Francisco State University. Studies show that within an averaged elapse lapsed time of 10 minutes, the temperature rise is an average of 19 degrees Fahrenheit.

For example, with an outside temperature of 80 degrees F., within ten minutes the average inside car temperature is 99 degrees F. Within twenty minutes, the average interior car temperature is 109 degrees F. “Heatstroke occurs when a person's temperature exceeds 104 degrees F. and their thermoregulatory mechanism is overwhelmed.” Id. “A core body temperature of 107 degrees F. is considered lethal as cells are damaged and internal organs shut down. Children's thermoregulatory systems are not as efficient as an adult's and their body temperatures warm at a rate 3 to 5 times faster than an adult's.” Id., See also, National Highway Traffic Safety Administration at www.nhtsa.gov. As a result, limiting the amount of time a child is exposed to high or extreme temperatures is critical.

Accordingly, what is needed is a system and method for reminding a caretaker when a child is left in a car seat so that remedial action can be taken promptly before injury or death occurs.

### SUMMARY OF THE INVENTION

Aspects of the present invention are directed to ensuring the safety of children in car seats, and the concomitant security and peace of mind of the caretaker in having an electronic reminder when the child is left in the car seat inadvertently.

A system in accordance with the present invention would, in a preferred embodiment, quickly remind caregivers as they leave the proximity of vehicle that the car seat is still in use or occupied. A reminder should prevent temperature or heat-related or hypothermia-related injury or deaths of infants and toddlers forgotten in car seats while in vehicles.

A system in accordance with the present invention may include four subsystems, possibly in addition to others: (1) an improved car seat buckle assembly; (2) an alarm subsystem; (3) a transmitter or transceiver; and (3) the portable alarm unit, which in a preferred embodiment is suitable to be attached to a key chain. The car seat buck assembly, alarm subsystem and/or transceiver may be physically connected or proximate or otherwise.

In a preferred embodiment, the car seat buckle is a lightweight buckle that can be attached to any car seat belt/harness. When the buckle is snapped together or engaged, it will transmit information to the remote receiver/transceiver. When the keychain is no longer within the immediate proximity of the engaged buckle (e.g., 20 or more feet away), the portable alarm will sound. The sound will indicate that the car seat buckle is engaged and remind the user that a child is potentially still in the vehicle.

Other advantages and features of the invention will become apparent from the following descriptions, the drawings, and the claims.

### BRIEF DESCRIPTION OF THE DRAWINGS

The foregoing and other advantages of the invention will become apparent from the following detailed description and upon reference to the drawings, wherein:

FIG. 1 shows a harness assembly in accordance with an aspect of the present invention;

FIG. 2 shows a seat belt adapter assembly in accordance with an aspect of the present invention;

FIG. 3 is a side view of a car seat configured with an alarm system in accordance with the present invention;

FIG. 4 is a detail view of an embodiment of the modular unit in accordance with one aspect of the present invention; and

FIG. 5 is a system-level diagram showing an embodiment of the alarm unit of the present invention in a usage scenario.

### DESCRIPTION OF ILLUSTRATIVE EMBODIMENTS

Following is a detailed description of illustrative embodiments of the invention with reference to the drawings wherein the same reference labels are used for the same or similar elements. It should be noted that the drawings are provided for illustrative purposes only and are not drawn to any particular dimensional scale and do not suggest a preference for any particular configuration.

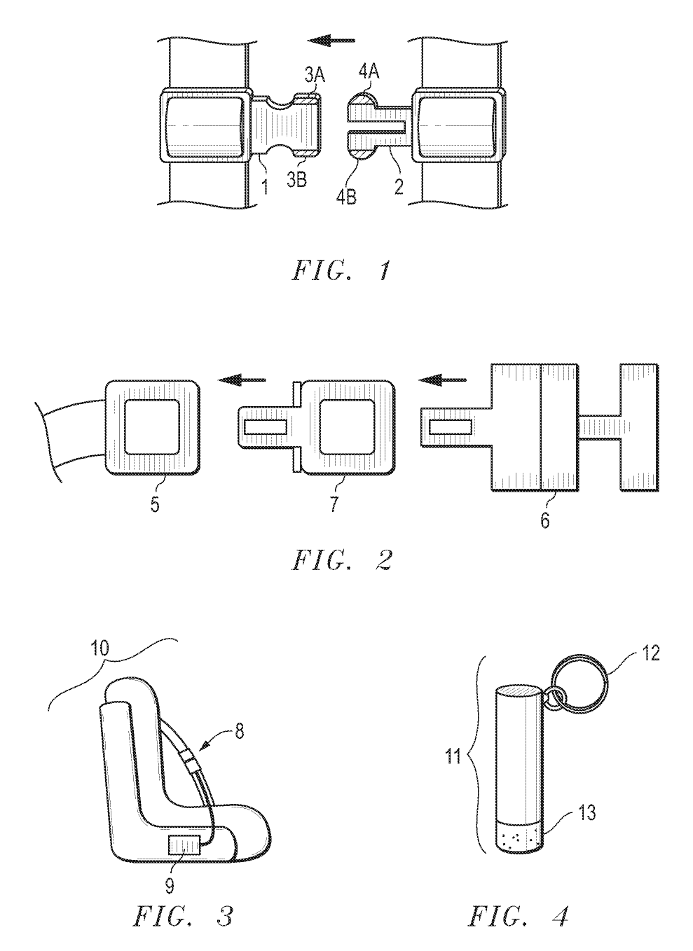

As seen in reference to FIG. 1, the car seat alarm system of the present invention can be implemented in a modified convention chest harness 1, including female 1 and male 2 interlocking members. An electrical signal is dependent upon engagement of female contacts (3A, 3B) and male contacts (4A, 4B). Interposed between female 1 and male 2 members is a specially-adapted component carrying contact circuitry necessary to generate the electrical signal used to generate an alarm, as discussed below. In this way, conventional car seats may be efficiently retrofitted with the present invention without the need for complete replacement.

FIG. 2 shows a buckle assembly in accordance with another aspect of the present invention, also including female 5 and male 6 members. Interposed between female 5 and male 6 members is a specially-adapted component carrying contact circuitry necessary to generate the electrical signal used to generate an alarm, as discussed below. In this way, conventional car seats may be efficiently retrofitted with the present invention without the need for complete replacement.

The electrical signal generated by the contacts in communicatively coupled to a control unit (not shown), which determines the existence of an emergent condition and when to instantiate an alarm transmission by a wireless transmitter or transceiver. The transmitter or transceiver may be attached to the buckle assembly or be electrically coupled thereto, either directly or wirelessly.

FIG. 3 shows a car seat 10 to which an embodiment of the present invention has been applied. As discussed above, contacts on belt assembly 8 generate an electrical signal that is used together with other data by the control unit to determine an emergent condition. The circuitry, including the control unit and transmitter/transceiver, and power supply, may be housed in electronics unit 9. While shown attached to a side of the car seat 10 in this implementation, a person of ordinary skill in the art will readily appreciate that electronics unit 9 may be deployed in any convenient location, or its circuitry and power (e.g., batteries) located in separate locations, so long as communicatively coupled to either or both the buckle or the harness.

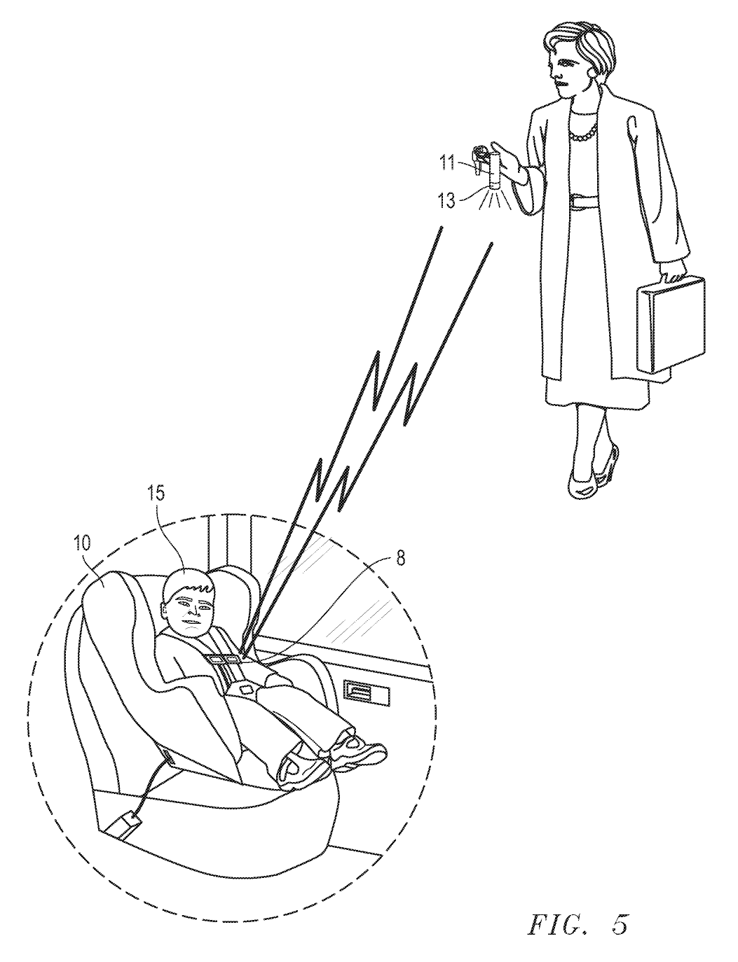

FIG. 4 is an embodiment of the portable alarm unit 11. The alarm unit 11 is intended to be carried by the person responsible for the child, and includes alarm speaker 12 adapted to emit a suitable alarm signal. In a preferred embodiment, the alarm unit 11 further includes an attachment mechanism 13 suitable for convenient attachment to a keyring or other portable item.

FIG. 5 is a high-level system diagram showing an embodiment of the overall system in operation. Here, child 15 is situated in car seat 10. Belt assembly 8 senses contact between male and female members (not shown), and that signal is communicated to electronics unit 7. The control unit processes this information along with other information such as proximity to portable alarm unit 11, temperature, or a vehicle off condition for a predetermined time, and determines an emergent condition. A signal from the transceiver in electronics unit 7 is then transmitted to portable alarm unit 11, where alarm speaker 13 is sounded.

As referenced above, embodiments of the invention may provide an alarm routed to portable alarm unit. In a preferred embodiment, the portable alarm unit is suitable for attachment to a key ring. Alternatively, the alarm may be transmitted to a mobile phone or PDA, or other phone such as home or office phones, emergency phones and/or a monitoring service. The system may further include programmable memory to provide for the storage of a series of numbers to be called or other steps (discussed below) to be taken in sequence.

Alternatively, the alarm may take other forms, such as text or SMS messaging, audio alarm, visual alarm, or other wireless communication such as email or WiFi. A practioner will readily understand that other forms of wireless communication may be suitably adapted to the alarm function.

In addition to or in lieu of the sensor on the buckle, the system may be adapted to include a weight sensor in the seat. Analogous weight sensors are commonly deployed in automotive seats as OEM equipment. The weight sensor can be programmed to detect a range of weights associated with the use of the seat and accordingly whether the seat is occupied.

The system may be further adapted to determine whether the automobile is engaged, whether a key is in the ignition or whether (in the case of keyless ignitions) a key is in proximity of the vehicle.

The system may be further adapted to incorporate a distance detection device, so that for example an alarm is not issued when a parent is loading or unloading the vehicle. The distance detection may be completed through range detection sensors such as IR sensors, ultrasonic or other acoustic sensors, capacitive sensors, inductive sensors, radio sensors or through calculations based on GPS or other navigational coordinates.

An alarm generation module receives inputs from one or more data inputs and generates an alarm based on rules or algorithms. These rules or algorithms may be simple or complex. For example, in yet another embodiment, the system incorporates a timer mechanism that issues an alarm only after an emergent condition has been detected for a specified period, such as ten seconds. The system may further incorporate a temperature sensor within the vehicle. The temperature sensor may be used as further input for alarm input data.

The system may include programmable memory that allows for the entry of a user's preferred method of contact in addition to or in lieu of the portable alarm unit. The programmable system may be adapted to incorporate two or more tiers of alarm dependent on the severity of the detected conditions. For example, 911 may be called upon the passage of a specified period of time or upon detection of a specified temperature.

While the present invention has been described with reference to one or more particular embodiments, those skilled in the art will recognize that many changes may be made thereto without departing from the spirit and scope of the present invention. For example, although the buckle assembly has been shown in a particular configuration and location, those having ordinary skill in the art will understand that the depicted configuration and location are exemplary only, and that other suitable implementations may be used without departing from the spirit and scope of the invention. Each of these embodiments and obvious variations thereof is therefore contemplated as falling within the spirit and scope of the claimed invention, which is set forth in the following claims.

What is claimed is:

1. A alarm system for a car seat comprising:
a buckle assembly having a buckle and a sensor adapted to determine whether the buckle is engaged and generate an engagement signal;
an alarm generation module adapted to receive said engagement signal and generate an alarm signal upon detection of an alarm condition; and
a transmitter electrically coupled to said alarm generation module adapted to wirelessly transmit an alarm to a portable alarm unit.

2. The car seat alarm system of claim 1, further comprising a programmable memory.

3. The car seat alarm system of claim 1, wherein the portable alarm unit is adapted to attachment to a key ring.

4. The car seat alarm system of claim 1, further comprising one or more of an audio alarm and a visual alarm.

5. The car seat alarm system of claim 1, further comprising a weight sensor deployed in the car seat, said weight sensor adapted to provide a weight input to said alarm generation module.

6. The car seat alarm system of claim 1, further comprising a distance detection subsystem, said distance detection subsystem adapted to provide a distance input to said alarm generation module.

7. The car seat alarm system of claim 1, further comprising a timing subsystem, said time subsystem adapted to provide a timing input to said alarm generation module.

8. The car seat alarm system of claim 1, further comprising a temperature sensor, said temperature sensor adapted to provide a temperature input to said alarm generation module.

9. The car seat alarm system of claim 1, further comprising a temperature sensor, said temperature sensor adapted to provide a temperature input to said alarm generation module.

10. The car seat alarm system of claim 1, further comprising a vehicle operation sensor for determining one or more of whether a vehicle is engaged, whether a key is in the vehicle ignition or whether a key is in proximity of the vehicle.

11. A method of promptly alerting that a child has been left in a car seat having a belt buckle assembly, comprising:
detecting whether a car seat belt buckle is engaged, thereby generating an engagement signal;
detecting a proximity between a portable alarm device and said car seat, thereby generating a proximity signal;
processing at least said engagement signal and said proximity signal to determine the existence of an emergent condition; and
upon determining an emergent condition, transmitting an alarm signal to said portable alarm device if said car seat belt buckle is engaged and said proximity exceeds a specified distance.

12. The method of generating an alert of claim 11, further comprising generating one or more of an audio alarm and a visual alarm.

13. The method of generating an alert of claim 11, further comprising detecting a weight signal, and processing said weight signal when determining said emergent condition.

14. The method of generating an alert of claim 11, further comprising detecting an elapsed time, and processing said elapsed time when determining said emergent condition.

15. The method of generating an alert of claim 11, further comprising detecting a temperature, and processing said temperature when determining said emergent condition.

16. The method of generating an alert of claim 11, further comprising sensing a vehicle operation signal, and processing said vehicle operation signal when determining said emergent condition.
